(19) United States
(12) Patent Application Publication
(10) Pub. No.: US 2013/0189855 A1
(43) Pub. Date: Jul. 25, 2013

(54) CONNECTOR ASSEMBLY

(71) Applicant: Ming-Chun Lai, New Taipei (TW)

(72) Inventor: Ming-Chun Lai, New Taipei (TW)

(21) Appl. No.: 13/354,311

(22) Filed: Jan. 19, 2012

(51) Int. Cl. H01R 11/30

(52) U.S. Cl. 439/39

(57) ABSTRACT

A connector assembly includes a female connector and a male connector. The female connector includes an insulating housing defining a mating cavity, probe pins assembled in one side of the insulating housing and projecting into the mating cavity, and a magnetic block mounted to the insulating housing. The male connector includes a base body made of metal material and having one end match with the mating cavity to be defined as a mating end, an insulating body embedded in one side of the base body, and electrical pillars inserted in the insulating body in accordance with the probe pins. When the male connector is connected with the female connector, the mating end is inserted in the mating cavity and steadily positioned in the mating cavity by virtue of the magnetic block attracting the base body to make the probe pins electrically resist in the corresponding electrical pillars.

### BACKGROUND OF THE INVENTION

1. Field of the Invention

The present invention relates to a connector assembly, and more particularly to a connector assembly including a male connector and a female connector which are connected with each other by virtue of magnetic attraction.

2. The Related Art

At present, a connector assembly which includes a female connector and a male connector connected with each other by virtue of magnetic attraction relates to a probe connector assembly often used in a smart phone, a liquid crystal display, a digital camera and so on. The probe connector assembly utilizes resist contact of probe pins and mating electrical pillars to realize an electrical connection between the female connector and the male connector. However, the above-mentioned resist contact of the probe pins and the mating electrical pillars is the method of point contact. As a result, the electrical connection between the female connector and the male connector is apt to be influenced by the instability of external environments. Therefore, a connector assembly capable of overcoming the foregoing problem is required.

### SUMMARY OF THE INVENTION

Accordingly, an object of the present invention is to provide a connector assembly. The connector assembly includes a female connector and a male connector adapted for being connected with the female connector. The female connector includes an insulating housing having a base portion of which a mating surface is concaved inward to form a mating cavity, a plurality of probe pins assembled in one side of the insulating housing and further elastically projecting into the mating cavity, a magnetic block mounted to the insulating housing and located behind the base portion, and a first shielding shell mounted to the insulating housing to enclose the magnetic block. The male connector includes a base body made of metal material and having one end match with the mating cavity of the insulating housing to be defined as a mating end, an insulating body embedded in one side of the base body and facing the probe pins, a plurality of electrical pillars inserted in the insulating body in accordance with the probe pins, and a second shielding shell mounted to the base body to enclose a part of the base body, the insulating body and the electrical pillars and expose the mating end outward. Each electrical pillar has a contact end concaved inward and exposed outside to face the corresponding probe pin. When the male connector is connected with the female connector, the mating end of the base body is inserted in the mating cavity of the insulating housing and steadily positioned in the mating cavity by virtue of the magnetic block attracting the base body so as to make the probe pins electrically resist in the contact ends of the corresponding electrical pillars.

As described above, the connector assembly of the present invention can achieve a steady electrical connection between the female connector and the male connector even if the probe pin and the corresponding electrical pillar resist against each other by the way of point contact, and even if the connector assembly is under an instable external environment.

### BRIEF DESCRIPTION OF THE DRAWINGS

The present invention will be apparent to those skilled in the art by reading the following description thereof, with reference to the attached drawings, in which:

FIG. 1 and FIG. 2 are different angles of perspective views of a connector assembly according to an embodiment of the present invention, showing that a female connector is disconnected from a male connector; and

FIG. 3 is a perspective view of the connector assembly of FIG. 1, showing that the female connector is connected with the male connector.

### DETAILED DESCRIPTION OF THE EMBODIMENT

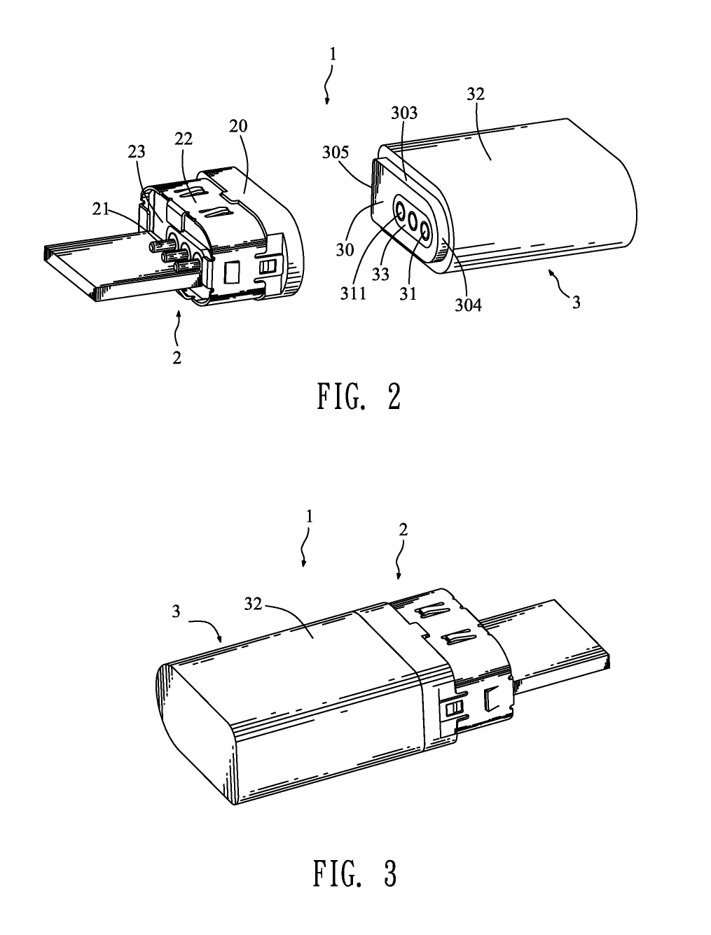

Referring to FIG. 3, a connector assembly 1 according to an embodiment of the present invention is adapted to be used in a smart phone, a liquid crystal display, a digital camera and other electronic products. The connector assembly 1 includes a female connector 2 and a male connector 3 adapted for being connected with the female connector 2 by virtue of magnetic attraction.

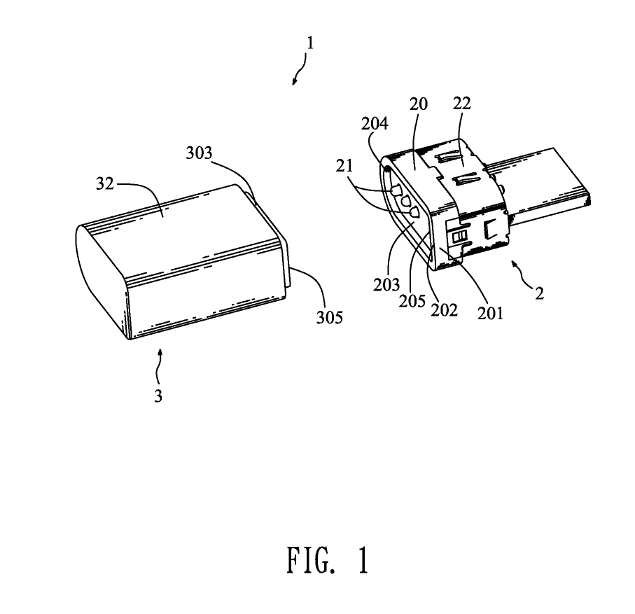

With reference to FIGS. 1-3, the female connector 2 includes an insulating housing 20, a plurality of probe pins 21, a magnetic block 23 and a first shielding shell 22. The insulating housing 20 has a base portion 201 of which a mating surface 202 is concaved inward to form a mating cavity 203. The probe pins 21 are assembled in one side of the insulating housing 20 and further elastically project into the mating cavity 203. The magnetic block 23 is mounted to the insulating housing 20 and located behind the base portion 201. The first shielding shell 22 is mounted to the insulating housing 20 to enclose the magnetic block 23. The male connector 3 includes a base body 30, an insulating body 33, a plurality of electrical pillars 31 and a second shielding shell 32. The base body 30 is made of metal material and has one end match with the mating cavity 203 of the insulating housing 20 to be defined as a mating end 303. The insulating body 33 is embedded in one side of the base body 30 and faces the probe pins 21. The electrical pillars 31 are inserted in the insulating body 33 in accordance with the probe pins 21. The second shielding shell 32 is mounted to the base body 30 to enclose a part of the base body 30, the insulating body 33 and the electrical pillars 31 and expose the mating end 303 outward. Each electrical pillar 31 has a contact end 311 concaved inward and exposed outside to face the corresponding probe pin 21. When the male connector 3 is connected with the female connector 2, the mating end 303 of the base body 30 is inserted in the mating cavity 203 of the insulating housing 20 and steadily positioned in the mating cavity 203 by virtue of the magnetic block 23 attracting the base body 30 so as to make the probe pins 21 electrically resist in the contact ends 311 of the corresponding electrical pillars 31. In the embodiment, the mating end 303 of the base body 30 is made of powder metallurgy.

Referring to FIG. 1 and FIG. 2 again, a periphery inner sidewall of the mating cavity 203 of the female connector 2 has one end designed with an arc-shaped face 204 and the other opposite end designed with a flat face 205. The mating end 303 of the male connector 3 has the same outer profile as the inner profile of the mating cavity 203, and accordingly has an arc-shaped end 304 and a flat end 305. So that can effectively avoid a misplug of the male connector 3 and the female connector 2. At least one of the probe pins 21 is eccentrically disposed in the one side of the insulating housing 20 with respect to other probe pins 21 so as to avoid unnecessary contact of the probe pins 21 and the electrical pillars 31 when the misplug is happened between the male connector 3 and the female connector 2. In the embodiment, the female connector 2 and the male connector 3 respectively have three probe pins 21 and three electrical pillars 31, and one of the probe pins 21 located between other two probe pins 21 is eccentrically assembled in the one side of the insulating housing 20 with respect to the other two probe pins 21.

As described above, the connector assembly 1 of the present invention can achieve a steady electrical connection between the female connector 2 and the male connector 3 even if the probe pin 21 and the corresponding electrical pillar 31 resist against each other by the way of point contact, and even if the connector assembly 1 is under an instable external environment.

What is claimed is:

1. A connector assembly, comprising:
a female connector including
an insulating housing having a base portion of which a mating surface is concaved inward to form a mating cavity,
a plurality of probe pins assembled in one side of the insulating housing and further elastically projecting into the mating cavity,
a magnetic block mounted to the insulating housing and located behind the base portion, and
a first shielding shell mounted to the insulating housing to enclose the magnetic block; and
a male connector adapted for being connected with the female connector and including
a base body made of metal material and having one end match with the mating cavity of the insulating housing to be defined as a mating end,
an insulating body embedded in one side of the base body and facing the probe pins,
a plurality of electrical pillars inserted in the insulating body in accordance with the probe pins, each electrical pillar having a contact end concaved inward and exposed outside to face the corresponding probe pin, and
a second shielding shell mounted to the base body to enclose a part of the base body, the insulating body and the electrical pillars and expose the mating end outward,
wherein when the male connector is connected with the female connector, the mating end of the base body is inserted in the mating cavity of the insulating housing and steadily positioned in the mating cavity by virtue of the magnetic block attracting the base body so as to make the probe pins electrically resist in the contact ends of the corresponding electrical pillars.

2. The connector assembly as claimed in claim 1, wherein a periphery inner sidewall of the mating cavity of the female connector has one end designed with an arc-shaped face and the other opposite end designed with a flat face, the mating end of the male connector has the same outer profile as the inner profile of the mating cavity, and accordingly has an arc-shaped end and a flat end.

3. The connector assembly as claimed in claim 1, wherein at least one of the probe pins is eccentrically disposed in the one side of the insulating housing with respect to other probe pins.

4. The connector assembly as claimed in claim 1, wherein the mating end of the base body is made of powder metallurgy.
